(19) United States
(12) Patent Application Publication
(10) Pub. No.: US 2013/0102308 A1
(43) Pub. Date: Apr. 25, 2013

(54) METHOD AND APPARATUS FOR DYNAMIC AGENT SELECTION IN A COMMUNICATIONS NETWORK

(71) Applicants: Basavaraj PATIL, Irving, TX (US); Gabor BAJKO, Sunnyvale, CA (US)

(72) Inventors: Basavaraj PATIL, Irving, TX (US); Gabor BAJKO, Sunnyvale, CA (US)

(21) Appl. No.: 13/279,964

(22) Filed: Oct. 24, 2011

(51) Int. Cl. H04W 40/20

(52) U.S. Cl. 455/435.1

(57) ABSTRACT

Various methods dynamic agent selection in a communications network are provided. One example method includes receiving a care-of address for a mobile node and determining a target home agent gateway device to operate as a home agent for the mobile node based on the care-of address for the mobile node. The example method also includes causing the mobile node to be notified of the target home agent gateway device in preparation to trigger a binding of the target home agent gateway device to a device associated with the care-of address. In this regard, at least one subsequent data session involving the mobile node may be routed to the target home agent with which registration has been performed. Similar and related example methods and example apparatuses are also provided.

### TECHNICAL FIELD

Embodiments of the present invention relate generally to the network management, and, more particularly, relate to a method and apparatus for dynamic agent selection in a communications network, such as, for example, an interne protocol mobile network.

### BACKGROUND

The modern communications era has brought about a tremendous expansion of wireline and wireless networks. Various types of networking technologies have been developed resulting in unprecedented expansion of computer networks, television networks, telephony networks, and the like, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices and other computing devices. As these technologies evolve, user demand for more processing power and more communications bandwidth in more convenient form factor (for example, handhelds, tablets, or the like) continue to keep pace. As such, increasingly innovative techniques for facilitating high-speed, reliable network connectivity are needed to meet the user demands.

### BRIEF SUMMARY

Example methods and example apparatuses for dynamic agent selection in a communications network are provided. One example method may include receiving a care-of address for a mobile node and determining a target home agent gateway device to operate as a home agent for the mobile node based on the care-of address for the mobile node. The example method may also include causing the mobile node to be notified of the target home agent gateway device in preparation to trigger a binding of the target home agent gateway device to a device associated with the care-of address. In this regard, at least one subsequent data session involving the mobile node is routed to the target home agent with which registration has been performed.

An additional example embodiment is an apparatus comprising at least one processor and at least one memory including computer program code. The at least one memory and the computer program code may be configured to, with the at least one processor, direct the example apparatus to perform various functionality. In this regard, the example apparatus may be directed to perform receiving a care-of address for a mobile node and determining a target home agent gateway device to operate as a home agent for the mobile node based on the care-of address for the mobile node. The example apparatus be directed to perform causing the mobile node to be notified of the target home agent gateway device to in preparation trigger a binding of the target home agent gateway device to a device associated with the care-of address. At least one subsequent data session involving the mobile node may be routed to the target home agent with which registration has been performed.

Another example embodiment is an example non-transitory computer readable medium having computer program code stored thereon. When executed, the computer program may direct an apparatus to perform receiving a care-of address for a mobile node and determining a target home agent gateway device to operate as a home agent for the mobile node based on the care-of address for the mobile node. The computer program may also direct the apparatus to perform causing the mobile node to be notified of the target home agent gateway device to in preparation trigger a binding of the target home agent gateway device to a device associated with the care-of address. At least one subsequent data session involving the mobile node may be routed to the target home agent with which registration has been performed.

Another example embodiment is an apparatus comprising means for receiving a care-of address for a mobile node and means for determining a target home agent gateway device to operate as a home agent for the mobile node based on the care-of address for the mobile node. The example apparatus may also include means for causing the mobile node to be notified of the target home agent gateway device in preparation to trigger a binding of the target home agent gateway device to a device associated with the care-of address. At least one subsequent data session involving the mobile node may be routed to the target home agent with which registration has been performed.

Another example method may include causing a communication to be sent that includes a care-of address for a mobile node, and receiving a response providing a home address of a target home agent, wherein the target home agent is determined based on the care-of address of the mobile node. The example method may further include triggering a binding of the target home agent gateway device to a device associated with the care-of address, wherein at least one subsequent data session involving the mobile node is routed to the target home agent with which registration has been performed.

An additional example embodiment is an apparatus comprising at least one processor and at least one memory including computer program code. The at least one memory and the computer program code may be configured to, with the at least one processor, direct the example apparatus to perform various functionality. In this regard, the example apparatus may be directed to perform causing a communication to be sent that includes a care-of address for a mobile node, and receiving a response providing a home address of a target home agent, wherein the target home agent is determined based on the care-of address of the mobile node. The example apparatus may be further directed to perform triggering a binding of the target home agent gateway device to a device associated with the care-of address, wherein at least one subsequent data session involving the mobile node is routed to the target home agent with which registration has been performed.

Another example embodiment is an example non-transitory computer readable medium having computer program code stored thereon. When executed, the computer program may direct an apparatus to perform causing a communication to be sent that includes a care-of address for a mobile node, and receiving a response providing a home address of a target home agent, wherein the target home agent is determined based on the care-of address of the mobile node. The program code may further direct the apparatus to perform triggering a binding of the target home agent gateway device to a device associated with the care-of address, wherein at least one subsequent data session involving the mobile node is routed to the target home agent with which registration has been performed.

Another example embodiment is an apparatus comprising means for causing a communication to be sent that includes a care-of address for a mobile node, and means for receiving a response providing a home address of a target home agent, wherein the target home agent is determined based on the care-of address of the mobile node. The example apparatus may further comprise means for triggering a binding of the target home agent gateway device to a device associated with the care-of address, wherein at least one subsequent data session involving the mobile node is routed to the target home agent with which registration has been performed.

### BRIEF DESCRIPTION OF THE DRAWING(S)

Having thus described some example embodiments in general terms, reference will now be made to the accompanying drawings, which are not necessarily drawn to scale, and wherein:

FIG. 1 illustrates a system for dynamic agent selection according to various example embodiments;

FIG. 2 illustrates a signaling diagram for determining a home agent during a bootstrapping process according to various example embodiments;

FIG. 3 illustrates a signaling diagram for determining a target home agent after having registered with a first home agent according to various example embodiments;

FIG. 4 illustrates an example format for a binding acknowledgment message according to various example embodiments;

FIG. 5 illustrates a block diagram of an apparatus configured to facilitate dynamic agent selection according to various example embodiments;

FIG. 6 illustrates a method for facilitating dynamic agent selection configured according to various example embodiments;

FIG. 7 illustrates a block diagram of another apparatus configured to facilitate dynamic agent selection according to various example embodiments;

FIG. 8 illustrates a block diagram of a more specific apparatus configured to facilitate dynamic agent selection according to various example embodiments; and

FIG. 9 illustrates another method for facilitating dynamic agent selection configured according to various example embodiments.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to any of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Mobile internet protocols, such as, for example Mobile IPv6 (internet protocol version 6) and Dual-stack Mobile IPv6 may have requirements that involve a mobile node being virtually anchored at a gateway device that is referred to as the home agent (HA) (or the home agent device). The home agent may provide the mobile node an IPv4 and/or IPv6 home address (HoA) which may be a persistent address that is used for the duration of a valid registration. As such, when the mobile node moves between different subnets or transitions to a different interface (for example, from a 3^{rd} Generation connection to a WiFi connection), registered internet protocol (IP) sessions need not experience a change in the IP address end-point identifier, since the home address can be used.

The home agent that is assigned to a mobile node may be unchanged for the duration of the registration, and the assignment of the home agent may be made by a server that is implementing a home agent controller (HAC), such as a home agent controller device. The home agent controller may additionally or alternatively be implemented on a server, such as an AAA (Authentication, Authorization, and Accounting) server which can be considered as a policy server within the network. Using information gathered at the time of access authentication, the AAA server may assign, via the home agent controller, the mobile node to a home agent, which then becomes the gateway to the Internet or other networks for mobile IP sessions involving the mobile node. During assignment the home agent controller may provide the mobile node with a home address of the home agent and various security keys to support secure communications.

In some instances, all traffic to the mobile node may be routed through the assigned home agent. As such, when the mobile node moves through the network away from the home agent, thereby introducing additional networking devices between the mobile node and the home agent, inefficiencies and other negative impacts can result. Such negative impacts can include, for example, increased latency, increased backhaul costs, and high cost gateway equipment needed to support the large number of connections involved in communications between the home agent and the mobile node. To minimize or avoid these issues, it would be advantageous to dynamically select the home agent based on the location and/or connection point of the mobile node, and permit the home agent to be reassigned to other candidate devices as the mobile node moves through the system and changes connection points.

As such, according to some example embodiments, subsequent to changing its connection point, a mobile node may have the option of avoiding or decreasing the negative impacts of a distant home agent by reassigning the mobile node to a different home agent device that, given its current location, can provide improved service to the mobile node, possibly at reduced costs. Dynamic reassignment of the home agent to different devices may be performed as a result of transitions within the same network or when the mobile moves between networks (for example, from 3rd Generation connection to a WiFi connection, or the like). According to various example embodiments, the assignment of a home agent may be determined based on the location of the connection point that the mobile node is using.

In this regard, the location of the connection point (for example, an access network router) may have an address that is assigned to the mobile node and referred to as the care-of address for the mobile node. The care-of address, and an associated access network router, may be used to assist in the routing of communications to the mobile node. In this regard, the home agent device for a mobile node may be bound to a access network router with the care-of address, and communications intended for the mobile node may be routed to the home agent, which in turn routes the communications to the access network router with the care-of address, which then forwards the communications to the mobile node. The care-of address can be dynamically assigned, and may change as the mobile node moves to different connection points in the network. As such, the care-of address can provide an indication of the location of the mobile node within the network. Various example embodiments leverage the location information provided by the care-of address to make dynamic selections and reassignments of home agents to improve communications performance and reduce costs. The use of the care-of address for this purpose may be leveraged during initial access authentication for the mobile node and on a continued basis to ensure that an improved connection may be realized.

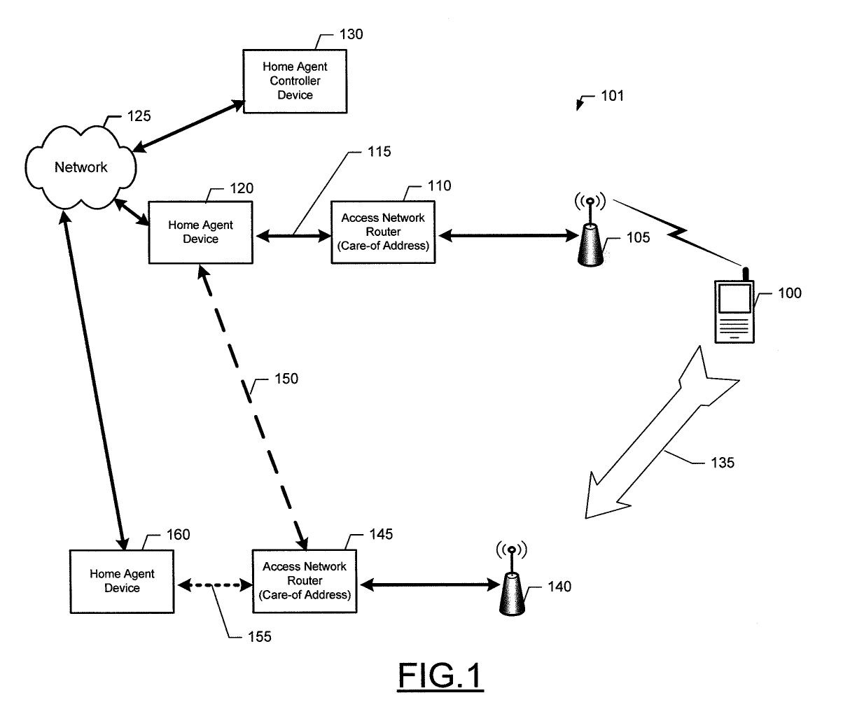

FIG. 1 is an illustration of a system 101 configured to facilitate dynamic agent selection, and more particularly, dynamic home agent selection in a mobile interne protocol (IP) environment. The system 101 may include components that are part of a mobile IP environment, such as, for example, a Mobile IPv6 environment, a Dual-stack Mobile IPv6 environment, or the like. Further, the system 101 may support distributed mobility management. The system 101 may include a mobile node 100, access network routers 110 and 145, home agent devices 120 and 160, and a home agent controller device 130, each of which may comprise electronic circuitry including a processor and memory configured to support the communications requirements for establishing a communications connection between the mobile node 100 and the network 125 as described herein. The mobile node 100 may be a mobile electronic wireless communications device (for example, smartphone, tablet, or the like). The access points 105 and 140 may include any type of wireless access points (for example, cellular base stations, Wi-Fi access points, or the like) and may be components of respective access networks. The access network routers 110 and 145, the home agent devices 120 and 160, and the home agent controller device 130 may be any type of network nodes (for example, hardware servers or the like) that are configured to support the operation of the communications network with respect to connecting the mobile node 100 to the network 125. The access network routers 110 and 145 and the home agent devices 120 and 160 may be gateway devices with respect to the mobile node 100 and the access network routers may have addresses that can be used as care-of addresses when assigned to a mobile node. In some example embodiments, the home agent controller device 130 may be embodied as, or part of, an AAA server. While FIG. 1 illustrates the access points, the access network routers, the home agent devices, and the home agent controller device as separate entities, it is contemplated that a single device may share the functionality of any two or more of these devices.

Currently, in FIG. 1, mobile node 100 is connected to the network 125 (for example, the interne, a wide area network, or the like) via access point 105, care-of address device 110, and home agent device 120. For the purpose of routing communications to the mobile node 100, the home agent device 120 may be bound to the access network router with the care-of address at connection 115. As further described below, the initial selection to assign home agent 120 to the mobile node 100 may have been performed by the home agent controller device 130 using the location information derived from the care-of address for access network router 110. In this regard, for example, the geographic location of the access network router 110 may have been determined, and the home agent device 120 may have been identified as being the closest candidate for home agent assignment. These operations may have been performed during the bootstrapping operations for the mobile device 100.

Despite being connected to access point 105, mobile node 100 may be physically moving in the direction 135 towards access point 140 and may soon be involved in a handover to access point 140 when a sufficient connection with access point 140 is established. Since mobile node 100 is in the process of being connected to a different access network that includes access point 140, the mobile node may receive or request and receive a new care-of address that is provided by the access network. After handover, the care-of address that is provided to the mobile node 100 may be the address of access network router 145, and, in turn, the mobile node 100 may provide this care-of address to home agent device 150 in a binding update to establish binding 150 between home agent device 120 and access network router 145. The binding 150 may be maintained to support ongoing data sessions. Additionally, home agent 120 may be configured to determine whether a change in the care-of address for the mobile node 100 has occurred, and, possibly with the assistance of the home agent controller device 130, determine whether a more desirable (for example, closer) candidate home agent device is available. In this instance, it is assumed that home agent device 160 is, for example, physically closer to the location associated with the care-of address and therefore a reassignment of the home agent role to the home agent device 160 may be appropriate. The mobile node may be informed of that an improved selection for its home agent is available and the mobile node 100, home agent device 120, and the home agent controller device 130 may facilitate reassigning the home agent for the mobile node 100 to the home agent 160 and establishing binding 155 between the home agent device 160 and the access network router 145 to support subsequently registered data sessions. As briefly described above with respect to FIG. 1, the care-of address information may be used in determining the home agent assignments for a mobile node. According to various example embodiments, use of the care-of address information may be leveraged for determining home agent assignment involving Mobile IPv6 sessions. Further, the care-of address information may be used for the assignment of the home agent at the time of initial registration (for example, at boot up of the mobile node), and with respect to subsequent registrations. An initial registration with an assigned home agent may occur at the time of boot up or during access authentication within a network.

For example, in a Mobile IPv6 environment or Dual-Stack Mobile IPv6 environment, a bootstrapping process may be performed which assigns the mobile node an IPv6 home address and the associated home agent. A server, such as the home agent controller device or an AAA server that assigns the home agent to the mobile node, may use the care-of address information in the assignment of a home agent to determine which home agent candidate would be desirable based on location. Moreover, the home agent controller (HAC) function and associated device may utilize care-of address information that is provided by the mobile node to determine a home agent assignment.

As mentioned above, the mobile node may be assigned a care-of address by the access network to which the mobile node is attached. The assigned care-of address may be anchored or associated with a gateway device, such as, for example, a packet data network (PDN) gateway in a 3^{rd} Generation Partnership Project (3GPP) network or at a Broadband Remote Access Server (BRAS) in a digital subscriber line (DSL) network. The home agent controller and the home agent may be notified of the care-of address information and the care-of address information may be used when selecting a home agent device. As such, based on various example embodiments, the care-of address may be explicitly indicated in communications from the mobile node to entities that are involved in the assignment and maintenance of the home agent, such as, for example, a home agent device, a home agent controller device, a bootstrapping server, and the like.

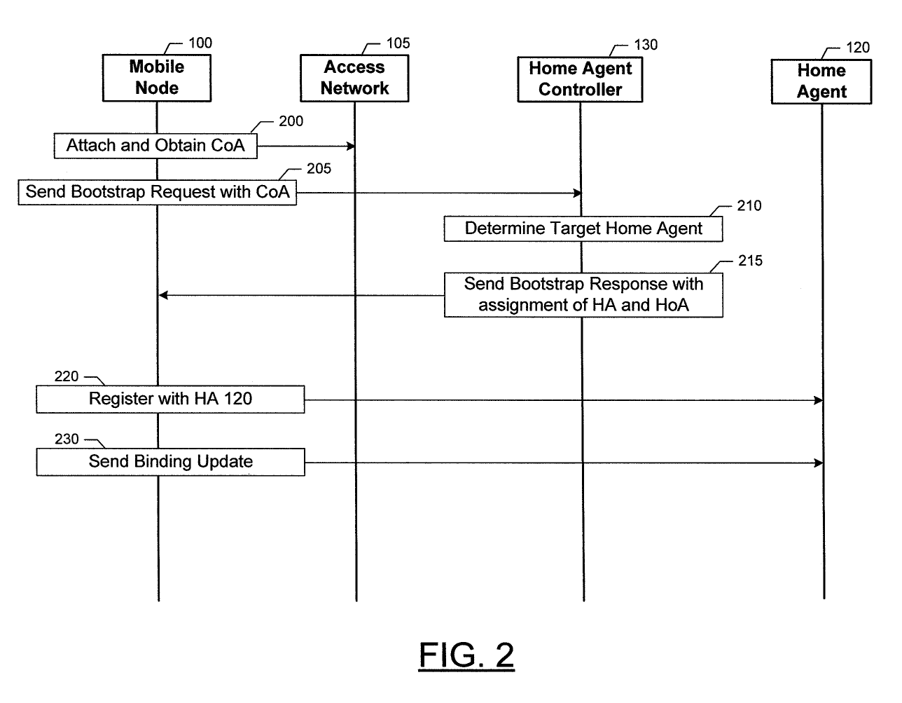

FIG. 2 is a signaling diagram and flowchart of operations that may be performed to assign a home agent during bootstrapping according to various example embodiments. The operations of FIG. 2 may be implemented as part of a bootstrapping procedure involving a home agent controller.

At 200, the mobile node 100 may attach to the access network and obtain a care-of address from the access network. The mobile node 100 might then send a bootstrap request that includes the care-of address to the home agent controller 130 at 205 and the mobile node 100 may establish a transport layer security (TLS) connection with the home agent controller 130. The bootstrap request or another communication to the home agent controller 130 may include the care-of address that was provided to the mobile node by the access network. In some example embodiments, the source address of the packets sent by the mobile node 100 may provide the care-of address.

In a case where the mobile node 100 is behind a network address translation (NAT) device in an IPv4 network, the mobile node 100 may only be aware of a private IPv4 address, which may be translated to a public IPv4 address by the NAT that is in the path. In such cases, the mobile node may include the care-of address, which may be set to be a private address, as an option in messages to the home agent controller 130. However, the home agent controller 130 may use the public IPv4 address that is replaced by the NAT function on the path as the care-of address. Alternatively, if the mobile node 100 is aware of the public address being assigned by the NAT, for example via techniques such as STUN (Session Traversal Utilities for NAT) or TURN (Traversal Using Relay NAT), then the mobile node 100 may include the public address in a care-of address optional field in a communication to the home agent controller 130. In the event that the care-of address optional field contains a private IPv4 address, the home agent controller 130 may consider the source address of a communication from the mobile node 100, such as the source address of a binding update, as the care-of address for the mobile node. If, on the other hand, the mobile node 100 is attached to an IPv6 network or a dual-stack access network, then the mobile node 100 may use the source IPv6 address as the care-of address, due to the absence of a NAT.

At 210, the home agent controller 130 may determine and identify a target home agent to be assigned to the mobile node 100 based on the care-of address provided by the mobile node 100. Upon determining the target home agent, the home agent controller 130 may also obtain the home address for the target home agent and keys (for example, security keys) for communications involving the home agent. In this regard, the point of attachment of the mobile node 100 can be considered when determining the target home agent via use of the care-of address. The home agent controller 130 may use the care-of address to determine a geographic location associated with the care-of address or a device represented by the care-of address, and identify a closest (for example, physically closest or closest in consideration of network topology) candidate home agent to be used as the home agent for the mobile node 100.

In some example embodiments, the home agent controller 130 may query an external or internal database that maintains a mapping of addresses (for example, care-of addresses) to a physical location. The query may be based on the care-of address for the mobile node 100 and the requested response may be the geographic location (for example, coordinates, region, service area, etc.) that has been mapped to the care-of address. The home agent controller 130 may also be configured to determine the closest candidate home agent to the location returned from the query.

At 215, the home agent controller 130 may be configured to send a bootstrap response to the mobile node 100 that identifies the target home agent. In this regard, the home agent controller 130 may provide bootstrapping information that includes an indication that home agent 120 is the target home agent, and provide the home address of the home agent 120. In some example embodiments, the home agent controller 130 may be configured to send a message that identifies a plurality of home agents that may be selected from by the mobile node 100, where the plurality of home agents includes the target home agent. The home agent controller 130 may also provide security keys to the mobile node 100.

In response to receiving notification of the target home agent, the mobile node 100 may be configured to register with the home agent 120 at 220. Subsequent to registering with the home agent 120, the mobile node 100 may be configured to send binding updates at 230 that indicate, among other things, the current care-of address for the mobile node 100. The mobile node 100 may send periodic binding updates. The binding updates may be used, for example, to keep a NAT binding alive or to indicate that a different care-of address has been assigned to the mobile node 100.

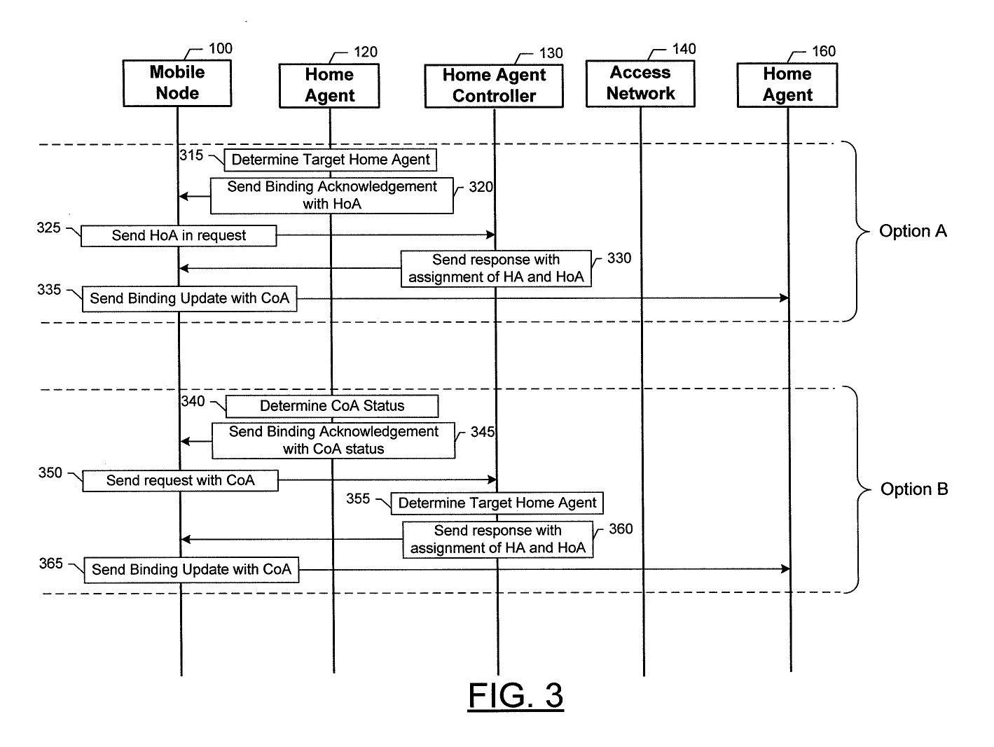

As described above, FIG. 2 illustrated example operations for initially registering with a target home agent that had been selected based on the mobile node's care-of address. FIG. 3 illustrates example operations that may be performed in instances where the mobile node 100 is transitioning between connections that involve updating the care-of address associated with the mobile node 100 after already being assigned a home agent.

The content of FIG. 3 is divided into two example options (Option A and Option B) for updating the home agent after an initial registration has occurred. In this regard, prior to operations 315 or 340, it is assumed that the mobile node 100 sent a binding update to the home agent 120 that identified a different care-of address due to, for example, movement of the mobile node 100 to a new location that involved a transition to a new access network.

With respect to example Option A, in response to receiving the binding update at 230, the home agent 120 may determine at 315 whether the binding update is sent from the former care-of address for the mobile node 100 or a different care-of address. To do so, the home agent 120 may extract the care-of address from the binding update, for example, from the source address field of a packet. According to some example embodiments, extraction from a source address field may be performed in instances where a private IPv4 address is being provided.

If the binding update indicates a different care-of address than a previous binding update, then the mobile node 100 may have moved to a different location and may be connected via a different connection point. According to some example embodiments, the move may be physical or logical, where a logical move may involve a connection to a different interface (for example, via a different virtual private networking gateway). Regardless of the type of move, the location of the home agent may have a significant impact on, for example, latency of data packets.

In an instance where the home agent 120 determines at 315 that the care-of address of the mobile node 100 has changed, the home agent 120 may determine if a more beneficial home agent device is available. According to some example embodiments, the home agent 120 may determine a geographic location associated with the care-of address and compare the distance between the geographic location associated with the care-of address and the home agent 120 to respective distances between the geographic location associated with the care-of address and the locations of other candidate home agents, such as, home agent 160. Home agent 160 may be identified as a target home agent for assignment to the mobile node 100 if the distance to the home agent 160 is the shortest. According to some example embodiments, a threshold deviation in the distance comparisons between the distance to the current home agent and the distance to the candidate home agent may need to be exceeded before a target home agent is identified.

According to some example embodiments, to determine a geographic location associated with a care-of address, the home agent 120 may query a database that, for example, may exist on an external server. As described above, the results of the query may be leveraged to determine a target home agent for the mobile node 100 based on the mobile node's care-of address. Alternatively, the home agent 120 may utilize a local policy based on the care-of address to determine whether to transition to a different home agent, and possibly rely upon the home agent controller 130 to determine the identity of the target home agent.

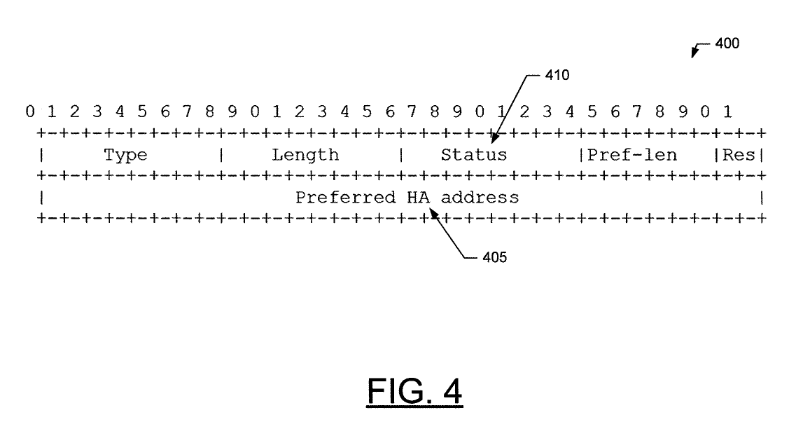

If the home agent 120 determines (for example, from the response received from the external address location mapping server or from locally stored information) that the mobile node 100 may benefit from a transition to a target home agent, the home agent 120 may send a binding acknowledgement to the mobile node 100 that includes the home address of the target home agent at 320. The binding acknowledgment may include the address of the target home agent in a target home agent suboption field of the binding acknowledgement. FIG. 4 illustrates a portion of the binding acknowledgement message 400 and the inclusion of a target/preferred home agent address suboption field 405.

In response to receiving the communication indicating the home address of the target home agent—in this instance the home address of home agent 160—the mobile node 100 may send the home agent address to the home agent controller 130 at 325. The presence of an address in the target home agent suboption field may trigger the mobile terminal to request a reassignment of the home agent. The home agent address may be sent in a request to reassign the mobile node 100 to the target home agent 160. Additionally, the mobile node 100 may establish a TLS connection to the home agent controller 130 to provide the address of the target home agent.

In response to the request sent by the mobile node 100, the home agent controller 130 may provide, at 330, a response to the mobile node with a home address of the target home agent 160 (for example, an IPv6 address) and keys to be used with the target home agent 160 indicating the assignment of home agent 160 to the mobile node 100. In some example embodiments, the home agent controller 130 may be configured to send a message that identifies a plurality of home agents that may be selected from by the mobile node 100, where the plurality of home agents includes the target home agent 160. The home agent controller 130 may also provide the target home agent 160 with the keys and the identity of the mobile node 100.

Subsequently, the mobile node 100 may perform a binding update at 335 with home agent 160 using the home address for the home agent 160 and the keys provided by the home agent controller 130. The binding update may indicate the current care-of address for the mobile node 100 and therefore, changes in the care-of address may be indicated in repeated binding updates.

According to some example embodiments, despite the transition to target home agent 160, ongoing data sessions between the home agent 120 and the mobile node 100 may continue uninterrupted. Upon completion of ongoing data sessions involving the home agent 120, the mobile node 100 may be configured to deregister with the home agent 120. Newly registered data sessions that originate or terminate at the mobile node 100 may utilize the home agent 160 and the associated home address. According to some example embodiments, the home agent may also update the fully qualified domain name (FQDN) of the mobile node 100 in the domain name system (DNS) with the home address of the home agent 160.

Referring now to Option B, upon receiving a binding update that indicates a change in the care-of address for the mobile node 100, the home agent 120 may determine at 340 a status indicating that a transition to a target home agent 160 would be beneficial. The home agent 120 may make this determination using the care-of address and querying an address-to-location mapping database as described above. At 345, the home agent 120 may provide a status indication that a transition to a target home agent would be beneficial in a binding acknowledgement. In this regard, according to various example embodiments, a home agent transition trigger value for a status field 410 of FIG. 4 in the binding acknowledgement may be used to indicate that a reselection and transition to target home agent may be performed.

In response to the binding acknowledgement, the mobile node 100 may be configured to connect to the home agent controller 130 over a TLS connection and send a request at 350 to be reassigned to a different home agent based on the mobile node 100's care-of address. In response, the home agent controller 130 may obtain the geographical information about the location of the care-of address, for example, from the external address-to-location mapping server. Based on the response and respective location comparisons, the home agent controller 130 may determine a target home agent 160. In some example embodiments, the home agent controller 130 may be configured to send a message that identifies a plurality of home agents that may be selected from by the mobile node 100, where the plurality of home agents includes the target home agent. The home agent controller 130 may also generate the necessary keys and associated bootstrap information for the mobile node 100 to register with the target home agent 160, and provide this information to the mobile node 100 in a response at 360. Further, the home agent controller 130 may update the target home agent 160 with the security information (for example, security keys) provided to the mobile node 100.

At 365, the mobile node may send a binding update to the home agent 160, while continuing to maintain ongoing data sessions previously anchored at home agent 120 until complete and then deregister from the home agent 120. Newly registered data sessions that may originate or terminate at the mobile node 100 may utilize home agent 160 and the associated home address. According to some example embodiments, the home agent may also update the fully qualified domain name (FQDN) of the mobile node 100 in the domain name system (DNS) with the home address of the home agent 160.

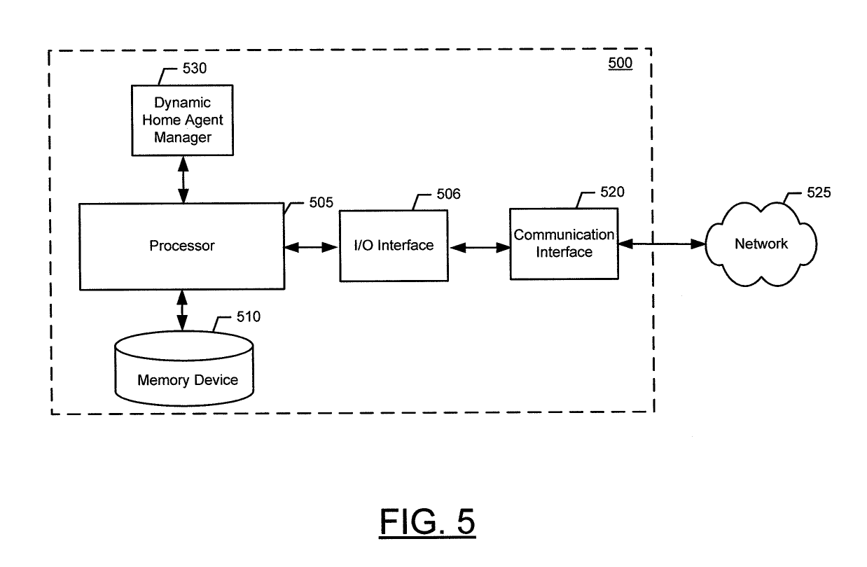

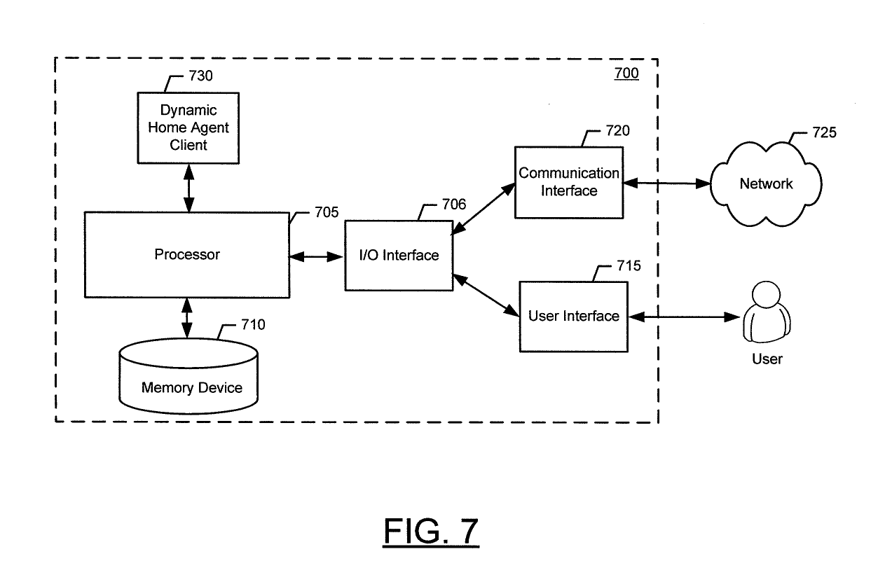

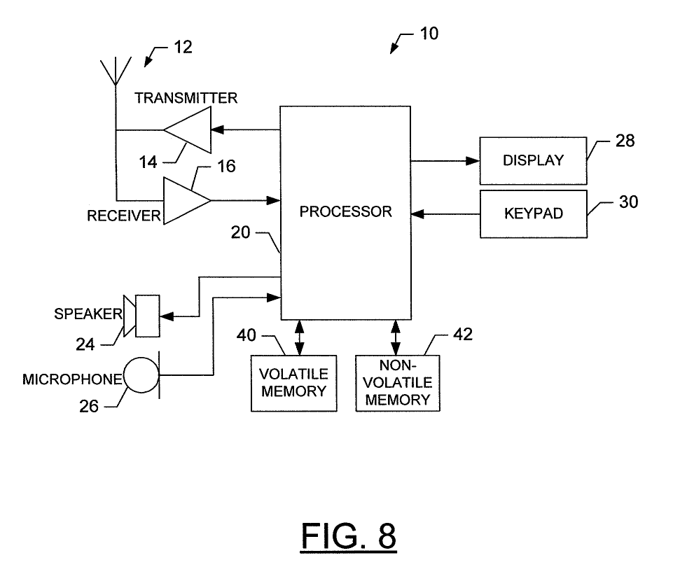

The description provided above and generally herein illustrates example methods, example apparatuses, and example computer programs stored on a non-transitory computer readable medium for dynamically selecting an agent (for example, a home agent) for a mobile node in a communications network. FIGS. 5, 7, and 8 illustrates example apparatus embodiments of the present invention configured to perform the various functionalities described herein. FIG. 5 depicts an example apparatus that is configured to perform various functionalities from the perspective of a home agent (for example, home agent device 120 or home agent device 160) or from the perspective of a home agent controller (for example, home agent controller device 130) as described with respect to FIGS. 1-4, 6, and as generally described herein. The example apparatus depicted in FIG. 5 may also be configured to perform example methods of the present invention, such as those described with respect to FIGS. 1-4 and 6. FIGS. 7 and 8 illustrate example apparatus example apparatus embodiments from the perspective of a mobile node (for example, mobile node 100) which may be configured to perform example methods of the present invention, such as those described with respect to FIGS. 1-4 and 9.

Referring now to FIG. 5, in some example embodiments, the apparatus 500 may be embodied as, or included as a component of, a communications device with wired and/or wireless communications capabilities. In this regard, the apparatus 500 may be configured to operate in accordance with the functionality of a network device as described herein. In some example embodiments, the apparatus 500 may be part of a communications device, such as a stationary network node. As a stationary network node, the apparatus 500 may be a computer, server, other network device, or the like. Regardless of the type of communications device, apparatus 500 may also include computing capabilities.

The example apparatus 500 includes or is otherwise in communication with a processor 505, a memory device 510, an Input/Output (I/O) interface 506, a communications interface 520, and a dynamic home agent manager 530. The processor 505 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 505 may be representative of a plurality of processors, or one or more multiple core processors, operating in concert. Further, the processor 505 may be comprised of a plurality of transistors, logic gates, a clock (for example, oscillator), other circuitry, and the like to facilitate performance of the functionality described herein. The processor 505 may, but need not, include one or more accompanying digital signal processors. In some example embodiments, the processor 505 is configured to execute instructions stored in the memory device 510 or instructions otherwise accessible to the processor 505. The processor 505 may be configured to operate such that the processor causes the apparatus 500 to perform various functionalities described herein.

Whether configured as hardware or via instructions stored on a computer-readable storage medium, or by a combination thereof, the processor 505 may be an entity capable of performing operations according to embodiments of the present invention while configured accordingly. Thus, in example embodiments where the processor 505 is embodied as, or is part of, an ASIC, FPGA, or the like, the processor 505 is specifically configured hardware for conducting the operations described herein. Alternatively, in example embodiments where the processor 505 is embodied as an executor of instructions or computer program code stored on a non-transitory computer-readable storage medium, the instructions specifically configure the processor 505 to perform the algorithms and operations described herein (for example, those described with respect to FIG. 5). In some example embodiments, the processor 505 is a processor of a specific device (for example, a mobile terminal) configured for employing example embodiments of the present invention by further configuration of the processor 505 via executed instructions for performing the algorithms, methods, and operations described herein.

The memory device 510 may be one or more non-transitory computer-readable storage media that may include volatile and/or non-volatile memory. In some example embodiments, the memory device 510 includes Random Access Memory (RAM) including dynamic and/or static RAM, on-chip or off-chip cache memory, and/or the like. Further, memory device 510 may include non-volatile memory, which may be embedded and/or removable, and may include, for example, read-only memory, flash memory, magnetic storage devices (for example, hard disks, floppy disk drives, magnetic tape, etc.), optical disc drives and/or media, non-volatile random access memory (NVRAM), and/or the like. Memory device 510 may include a cache area for temporary storage of data. In this regard, some or all of memory device 510 may be included within the processor 505.

Further, the memory device 510, which may be one or more memory devices, may be configured to store information, data, applications, computer-readable program code instructions, and/or the like for enabling the processor 505 and the example apparatus 500 to carry out various functions in accordance with example embodiments of the present invention described herein. For example, the memory device 510 could be configured to buffer input data for processing by the processor 505. Additionally, or alternatively, the memory device 510 may be configured to store instructions for execution by the processor 505.

The I/O interface 506 may be any device, circuitry, or means embodied in hardware, software, or a combination of hardware and software that is configured to interface the processor 505 with other circuitry or devices, such as the communications interface 520 and the user interface 515. In some example embodiments, the processor 505 may interface with the memory 510 via the I/O interface 506. The I/O interface 506 may be configured to convert signals and data into a form that may be interpreted by the processor 505. The I/O interface 506 may also perform buffering of inputs and outputs to support the operation of the processor 505. According to some example embodiments, the processor 505 and the I/O interface 506 may be combined onto a single chip or integrated circuit configured to perform, or cause the apparatus 500 to perform, various functionalities of the present invention.

The communication interface 520 may be any device or means (for example, circuitry) embodied in hardware, a computer program product, or a combination of hardware and a computer program product that is configured to receive and/or transmit data from/to a network 525 and/or any other device or module in communication with the example apparatus 500. The communications interface may be configured to communicate information via any type of wired or wireless connection, and via any type of communications protocol, such as a communications protocol that supports cellular communications or near field communications. According to various example embodiments, the communication interface 520 may be configured to support the transmission and reception of communications in a variety of networks including, but not limited to Internet Protocol-based networks (for example, the Internet), cellular networks, or the like. Processor 505 may also be configured to facilitate communications via the communications interface 520 by, for example, controlling hardware comprised within the communications interface 520. In this regard, the communication interface 520 may comprise, for example, communications driver circuitry (for example, circuitry that supports wired communications via, for example, fiber optic connections), one or more antennas, a transmitter, a receiver, a transceiver and/or supporting hardware, including, for example, a processor for enabling communications. Via the communication interface 520, the example apparatus 500 may communicate with various other network entities via direct or indirect communications involving a base station, access point, server, gateway, router, or the like.

The dynamic home agent manager 530 of example apparatus 500 may be any means or device embodied, partially or wholly, in hardware, a non-transitory computer readable medium having a computer program stored thereon, or a combination of hardware and a non-transitory computer readable medium having a computer program stored thereon, such as processor 505 implementing stored instructions to configure the example apparatus 500, or a hardware configured processor 505, that is configured to carry out the functions of the dynamic home agent manager 530 as described herein. In an example embodiment, the processor 505 includes, or controls, the dynamic home agent manager 530. The dynamic home agent manager 530 may be, partially or wholly, embodied as processors similar to, but separate from processor 505. In this regard, the dynamic home agent manager 530 may be in communication with the processor 505. In various example embodiments, the dynamic home agent manager 530 may, partially or wholly, reside on differing apparatuses such that some or all of the functionality of the dynamic home agent manager 530 may be performed by a first apparatus, and the remainder of the functionality of the dynamic home agent manager 530 may be performed by one or more other apparatuses.

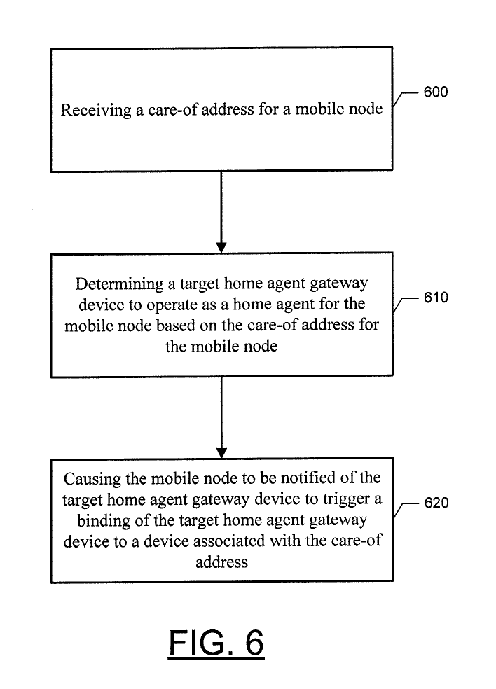

The apparatus 500 and the processor 505 may be configured to perform the following functionality via the dynamic home agent manager 530. In this regard, the dynamic home agent manager 530 may be configured to, for example, perform the example method of FIG. 6. In this regard, the dynamic home agent manager 530 may be configured to receive a care-of address for a mobile node at 600, and determine a target home agent gateway device to operate as a home agent for the mobile node based on the care-of address for the mobile node at 610. Further, at 620, the dynamic home agent manager 530 may be configured to cause the mobile node to be notified of the target home agent gateway device to trigger or prepare to trigger a binding of the target home agent gateway device to a device associated with the care-of address. In this regard, the binding may support at least one subsequent data session involving the mobile node that is routed to the target home agent with which registration has been performed.

According to some example embodiments, the dynamic home agent manager 530 may additionally or alternatively be configured to determine the target home agent gateway device by determining a geographic location associated with the care-of address and determining the target home agent gateway device based on the geographic location associated with the care-of address. Additionally or alternatively, the dynamic home agent manager 530 may be configured to receive the care-of address from the mobile node in a bootstrapping request or receive the care-of address as an updated care-of address in a binding update from the mobile node. In this regard, the updated care-of address may be provided in response to a transition by the mobile node from a subsequent care-of address to the updated care-of address.

According to some example embodiments, the dynamic home agent manager 530 may additionally or alternatively be configured to cause the mobile node to be notified in a bootstrap response that assigns the target home agent gateway device to the mobile node. Additionally or alternatively, the dynamic home agent manager 530 may, according to some example embodiments be configured to cause the mobile node to be notified by a home agent controller that assigns the target home agent gateway device to the mobile node. According to some example embodiments, the dynamic home agent manager 530 may be additionally or alternatively configured to determine the target home agent gateway device by a current home agent for the mobile node, and cause the mobile node to be notified of an address for the target home agent gateway device in a binding acknowledgement message. Additionally or alternatively, the dynamic home agent manager 530 may be configured to determine the target home agent gateway device by a current home agent for the mobile node, and cause the mobile node to be notified in a binding acknowledgement message that provides a status update indicating that a transition from the current home agent is available.

Referring now to FIG. 7, in some example embodiments, the apparatus 700 may, be embodied as, or included as a component of, a communications device with wired and/or wireless communications capabilities. In this regard, the apparatus 700 may be configured to operate in accordance with the functionality of a mobile node as described herein. In some example embodiments, the apparatus 700 may be part of a communications device (for example, mobile node 100), such as a stationary or a mobile terminal. As a mobile terminal, the apparatus 700 may be a mobile computer, mobile telephone, a portable digital assistant (PDA), a pager, a mobile television, a gaming device, a mobile computer, a laptop computer, a camera, a video recorder, an audio/video player, a radio, smart phone, tablet or pad device and/or a global positioning system (GPS) device, any combination of the aforementioned, or the like. Regardless of the type of communications device, apparatus 700 may also include computing capabilities.

The example apparatus 700 includes or is otherwise in communication with a processor 705, a memory device 710, an Input/Output (I/O) interface 706, a communications interface 720, user interface 715, and a dynamic home agent client 730. The processor 705 may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 705 may be representative of a plurality of processors, or one or more multiple core processors, operating in concert. Further, the processor 705 may be comprised of a plurality of transistors, logic gates, a clock (for example, oscillator), other circuitry, and the like to facilitate performance of the functionality described herein. The processor 705 may, but need not, include one or more accompanying digital signal processors. In some example embodiments, the processor 705 is configured to execute instructions stored in the memory device 710 or instructions otherwise accessible to the processor 705. The processor 705 may be configured to operate such that the processor causes the apparatus 700 to perform various functionalities described herein.

Whether configured as hardware or via instructions stored on a computer-readable storage medium, or by a combination thereof, the processor 705 may be an entity capable of performing operations according to embodiments of the present invention while configured accordingly. Thus, in example embodiments where the processor 705 is embodied as, or is part of, an ASIC, FPGA, or the like, the processor 705 is specifically configured hardware for conducting the operations described herein. Alternatively, in example embodiments where the processor 705 is embodied as an executor of instructions or computer program code stored on a non-transitory computer-readable storage medium, the instructions specifically configure the processor 705 to perform the algorithms and operations described herein. In some example embodiments, the processor 705 is a processor of a specific device (for example, a mobile terminal) configured for employing example embodiments of the present invention by further configuration of the processor 705 via executed instructions for performing the algorithms, methods, and operations described herein.

The memory device 710 may be one or more non-transitory computer-readable storage media that may include volatile and/or non-volatile memory. In some example embodiments, the memory device 710 includes Random Access Memory (RAM) including dynamic and/or static RAM, on-chip or off-chip cache memory, and/or the like. Further, memory device 710 may include non-volatile memory, which may be embedded and/or removable, and may include, for example, read-only memory, flash memory, magnetic storage devices (for example, hard disks, floppy disk drives, magnetic tape, etc.), optical disc drives and/or media, non-volatile random access memory (NVRAM), and/or the like. Memory device 710 may include a cache area for temporary storage of data. In this regard, some or all of memory device 710 may be included within the processor 705.

Further, the memory device 710, which may be one or more memory devices, may be configured to store information, data, applications, computer-readable program code instructions, and/or the like for enabling the processor 705 and the example apparatus 700 to carry out various functions in accordance with example embodiments of the present invention described herein. For example, the memory device 710 could be configured to buffer input data for processing by the processor 705. Additionally, or alternatively, the memory device 710 may be configured to store instructions for execution by the processor 705.

The I/O interface 706 may be any device, circuitry, or means embodied in hardware, software, or a combination of hardware and software that is configured to interface the processor 705 with other circuitry or devices, such as the communications interface 720 and the user interface 715. In some example embodiments, the processor 705 may interface with the memory 710 via the I/O interface 706. The I/O interface 706 may be configured to convert signals and data into a form that may be interpreted by the processor 705. The I/O interface 706 may also perform buffering of inputs and outputs to support the operation of the processor 705. According to some example embodiments, the processor 705 and the I/O interface 706 may be combined onto a single chip or integrated circuit configured to perform, or cause the apparatus 700 to perform, various functionalities of the present invention.

The communication interface 720 may be any device or means (for example, circuitry) embodied in hardware, a computer program product, or a combination of hardware and a computer program product that is configured to receive and/or transmit data from/to a network 725 and/or any other device or module in communication with the example apparatus 700. The communications interface may be configured to communicate information via any type of wired or wireless connection, and via any type of communications protocol, such as a communications protocol that supports cellular communications or near field communications. According to various example embodiments, the communication interface 720 may be configured to support the transmission and reception of communications in a variety of networks including, but not limited to Internet Protocol-based networks (for example, the Internet), cellular networks, or the like. Further, the communications interface 720 may be configured to support device-to-device communications, such as in a mobile ad hoc network (MANET). Processor 705 may also be configured to facilitate communications via the communications interface 720 by, for example, controlling hardware comprised within the communications interface 720. In this regard, the communication interface 720 may comprise, for example, communications driver circuitry (for example, circuitry that supports wired communications via, for example, fiber optic connections), one or more antennas, a transmitter, a receiver, a transceiver and/or supporting hardware, including, for example, a processor for enabling communications. Via the communication interface 720, the example apparatus 700 may communicate with various other network entities in a device-to-device fashion and/or via indirect communications via a base station, access point, server, gateway, router, or the like.

The user interface 715 may be in communication with the processor 705 to receive user input via the user interface 715 and/or to present output to a user as, for example, audible, visual, mechanical or other output indications. The user interface 715 may include, for example, a keyboard, a mouse, a joystick, a display (for example, a touch screen display), a microphone, a speaker, or other input/output mechanisms. Further, the processor 705 may comprise, or be in communication with, user interface circuitry configured to control at least some functions of one or more elements of the user interface. The processor 705 and/or user interface circuitry may be configured to control one or more functions of one or more elements of the user interface through computer program instructions (for example, software and/or firmware) stored on a memory accessible to the processor 705 (for example, volatile memory, non-volatile memory, and/or the like). In some example embodiments, the user interface circuitry is configured to facilitate user control of at least some functions of the apparatus 700 through the use of a display and configured to respond to user inputs. The processor 705 may also comprise, or be in communication with, display circuitry configured to display at least a portion of a user interface, the display and the display circuitry configured to facilitate user control of at least some functions of the apparatus 700.

The dynamic home agent client 730 of example apparatus 700 may be any means or device embodied, partially or wholly, in hardware, a non-transitory computer readable medium having a computer program stored thereon, or a combination of hardware and a non-transitory computer readable medium having a computer program stored thereon, such as processor 705 implementing stored instructions to configure the example apparatus 700, or a hardware configured processor 705, that is configured to carry out the functions of the dynamic home agent client 730 as described herein. In an example embodiment, the processor 705 includes, or controls, the dynamic home agent client 730. The dynamic home agent client 730 may be, partially or wholly, embodied as processors similar to, but separate from processor 705. In this regard, the dynamic home agent client 730 may be in communication with the processor 705. In various example embodiments, the dynamic home agent client 730 may, partially or wholly, reside on differing apparatuses such that some or all of the functionality of the dynamic home agent client 730 may be performed by a first apparatus, and the remainder of the functionality of the dynamic home agent client 730 may be performed by one or more other apparatuses.

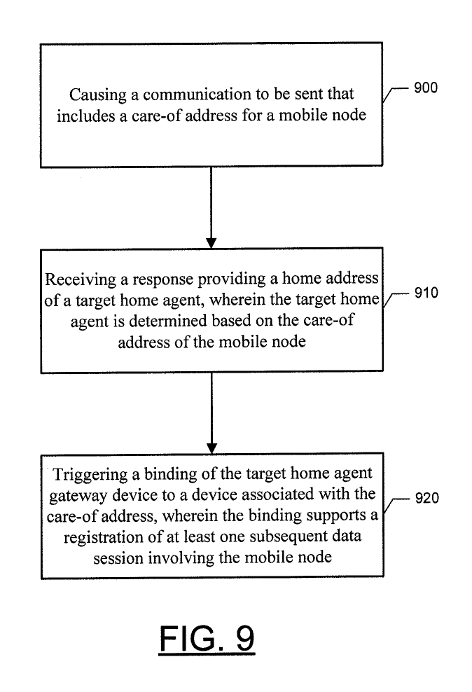

The apparatus 700 and the processor 705 may be configured to perform the following functionality via the dynamic home agent client 730. In this regard, the dynamic home agent client 730 may be configured to various operations described herein including but not limited to the operation of the example method of FIG. 9. In this regard, the dynamic home agent client 730 may be configured to cause a communication to be sent that includes a care-of address for a mobile node at 900. At 910, the dynamic home agent client 730 may be configured to receive a response providing a home address of a target home agent, where the target home agent may be determined based on the care-of address of the mobile node. Additionally, at 920, the dynamic home agent client 730 may be configured to trigger or prepare to trigger a binding of the target home agent gateway device to a device associated with the care-of address, where the binding may support a registration of at least one subsequent data session involving the mobile node.

Additionally or alternatively, according to some example embodiments, the dynamic home agent client 730 configured to cause the communication to be sent that includes the care-of address for the mobile node may be further configured to cause the communication to be sent as a bootstrap request to a home agent controller. According to some example embodiments, the dynamic home agent client 730 configured to receive the response providing a home address of the target home agent may be additionally or alternatively configured to receive the response as a binding acknowledgement. Further, according to some example embodiments, the dynamic home agent client 730 may be further configured to receive a binding acknowledgement with a status indicating that a transition to the target home agent is available.

Referring now to FIG. 8, a more specific example apparatus in accordance with various embodiments of the present invention is provided. The example apparatus of FIG. 8 is a mobile terminal 10 configured to communicate within a wireless network, such as a cellular communications network. The mobile terminal 10 may be configured to perform the functionality of mobile node 100 and/or apparatus 700 as described herein. In some example embodiments, the mobile terminal 10 may be caused to perform the functionality of the dynamic home agent client 730 via the processor 20. In this regard, processor 20 may be an integrated circuit or chip configured similar to the processor 705 together with, for example, the I/O interface 706. Further, volatile memory 40 and non-volatile memory 42 may configured to support the operation of the processor 20 as computer readable storage media.

The mobile terminal 10 may further include an antenna 12, a transmitter 14, and a receiver 16, which may be included as parts of a communications interface of the mobile terminal 10. The speaker 24, the microphone 26, the display 28, and the keypad 30 may be included as parts of a user interface.

As described above, FIGS. 2, 3, 6 and 9 illustrate flowcharts of example systems, methods, and/or computer programs stored on a non-transitory computer readable medium (for example, computer program product) according to example embodiments of the invention. It will be understood that each block or operation of the flowcharts, and/or combinations of blocks or operations in the flowcharts, can be implemented by various means. Means for implementing the blocks or operations of the flowcharts, combinations of the blocks or operations in the flowchart, or other functionality of example embodiments of the present invention described herein may include hardware, and/or a non-transitory computer-readable storage medium having one or more computer program code instructions, program instructions, or executable computer-readable program code instructions stored therein. In this regard, program code instructions may be stored on a memory device, such as memory devices 510 and 710, of an example apparatus, such as example apparatuses 500 and 700, and executed by a processor, such as processors 505 and 705. As will be appreciated, any such program code instructions may be loaded onto a computer or other programmable apparatus (for example, processors 505 and 705, memory devices 510 and 705, or the like) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowchart by a processor, or storage of instructions associated with the blocks or operations of the flowcharts in a computer-readable storage medium, support combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
receiving a care-of address for a mobile node;
determining, by a processor, a target home agent gateway device to operate as a home agent for the mobile node based on the care-of address for the mobile node; and
causing the mobile node to be notified of the target home agent gateway device in preparation to trigger a binding of the target home agent gateway device to a device associated with the care-of address, wherein at least one subsequent data session involving the mobile node is routed to the target home agent with which registration has been performed.

2. The method of claim 1, wherein determining the target home agent gateway device includes determining a geographic location associated with the care-of address and determining the target home agent gateway device based on the geographic location associated with the care-of address.

3. The method of claim 1, wherein receiving the care-of address for the mobile node includes receiving the care-of address from the mobile node in a bootstrapping request.

4. The method of claim 1, wherein receiving the care-of address for the mobile node includes receiving the care-of address as an updated care-of address in a binding update from the mobile node, the updated care-of address being provided in response to a transition by the mobile node from a previous care-of address to the updated care-of address.

5. The method of claim 1, wherein causing the mobile node to be notified of the target home agent gateway device includes causing the mobile node to be notified in a bootstrap response that assigns the target home agent gateway device to the mobile node.

6. The method of claim 1, wherein causing the mobile node to be notified of the target home agent gateway device includes causing the mobile node to be notified by a home agent controller that assigns the target home agent gateway device to the mobile node.

7. The method of claim 1, wherein determining the target home agent gateway device includes determining the target home agent gateway device near a current home agent for the mobile node; and wherein causing the mobile node to be notified of the target home agent gateway device includes causing the mobile node to be notified of an address for the target home agent gateway device in a binding acknowledgement message.

8. The method of claim 1, wherein determining the target home agent gateway device includes determining the target home agent gateway device by a current home agent for the mobile node; and wherein causing the mobile node to be notified of the target home agent gateway device includes causing the mobile node to be notified in a binding acknowledgement message that provides a status update indicating that a transition from the current home agent is available.

9. An apparatus comprising at least one processor and at least one memory including computer program code, the at least one memory and the computer program code configured to, with the at least one processor, direct the apparatus at least to:
receive a care-of address for a mobile node;
determine a target home agent gateway device to operate as a home agent for the mobile node based on the care-of address for the mobile node; and
cause the mobile node to be notified of the target home agent gateway device in preparation to trigger a binding of the target home agent gateway device to a device associated with the care-of address, wherein at least one subsequent data session involving the mobile node is routed to the target home agent with which registration has been performed.

10. The apparatus of claim 9, wherein the apparatus directed to determine the target home agent gateway device includes being directed to determine a geographic location associated with the care-of address and determining the target home agent gateway device based on the geographic location associated with the care-of address.

11. The apparatus of claim 9, wherein the apparatus directed to receive the care-of address for the mobile node includes being directed to receive the care-of address from the mobile node in a bootstrapping request.

12. The apparatus of claim 9, wherein the apparatus directed to receive the care-of address for the mobile node includes being directed to receive the care-of address as an updated care-of address in a binding update from the mobile node, the updated care-of address being provided in response to a transition by the mobile node from a subsequent care-of address to the updated care-of address.

13. The apparatus of claim 9, wherein the apparatus directed to cause the mobile node to be notified of the target home agent gateway device includes being directed to cause the mobile node to be notified in a bootstrap response that assigns the target home agent gateway device to the mobile node.

14. The apparatus of claim 9, wherein the apparatus directed to cause the mobile node to be notified of the target home agent gateway device includes being directed to cause the mobile node to be notified by a home agent controller that assigns the target home agent gateway device to the mobile node.

15. The apparatus of claim 9, wherein the apparatus directed to determine the target home agent gateway device includes being directed to determine the target home agent gateway device by a current home agent for the mobile node; and wherein the apparatus directed to cause the mobile node to be notified of the target home agent gateway device includes being directed to cause the mobile node to be notified of an address for the target home agent gateway device in a binding acknowledgement message.

16. The apparatus of claim 9, wherein the apparatus directed to determine the target home agent gateway device includes being directed to determine the target home agent gateway device by a current home agent for the mobile node; and wherein the apparatus directed to cause the mobile node to be notified of the target home agent gateway device includes being directed to cause the mobile node to be notified in a binding acknowledgement message that provides a status update indicating that a transition from the current home agent is available.

17. The apparatus of claim 9, wherein the apparatus further comprises a network communications interface configured to receive the care-of address and transmit a notification of the target home agent gateway device to the mobile node.

18. The apparatus of claim 17, wherein the apparatus further comprises a hardware server device connected to a mobile interne protocol network.

19. A method comprising:
causing a communication to be sent that includes a care-of address for a mobile node;
receiving a response providing a home address of a target home agent, wherein the target home agent is determined based on the care-of address of the mobile node; and
triggering a binding of the target home agent gateway device to a device associated with the care-of address, wherein at least one subsequent data session involving the mobile node is routed to the target home agent with which registration has been performed.

20. The method of claim 19, wherein causing the communication to be sent that includes the care-of address for the mobile node includes causing the communication to be sent as a bootstrap request to a home agent controller.

21. The method of claim 19, wherein receiving the response providing a home address of the target home agent includes receiving the response as a binding acknowledgement.

22. The method of claim 19, further comprising receiving a binding acknowledgement with a status indicating that a transition to the target home agent is available.

23. An apparatus comprising at least one processor and at least one memory including computer program code, the at least one memory and the computer program code configured to, with the at least one processor, direct the apparatus at least to:
cause a communication to be sent that includes a care-of address for a mobile node;
receive a response providing a home address of a target home agent, wherein the target home agent is determined based on the care-of address of the mobile node; and
trigger a binding of the target home agent gateway device to a device associated with the care-of address, wherein at least one subsequent data session involving the mobile node is routed to the target home agent with which registration has been performed.

24. The apparatus of claim 23, wherein the apparatus directed to cause the communication to be sent that includes the care-of address for the mobile node includes being directed to cause the communication to be sent as a bootstrap request to a home agent controller.

25. The apparatus of claim 23, wherein the apparatus directed to receive the response providing a home address of the target home agent includes being directed to receive the response as a binding acknowledgement.

26. The apparatus of claim 23, wherein the apparatus is further directed to receive a binding acknowledgement with a status indicating that a transition to the target home agent is available.

27. The apparatus of claim 23, wherein the apparatus comprises a mobile communications device.
